(19) United States
(12) Patent Application Publication
(10) Pub. No.: US 2005/0257622 A1
(43) Pub. Date: Nov. 24, 2005

(54) Precision adjustable bi-directional load-sensing mechanism and method of use

(76) Inventor: Jan S. Stasiek, Hilton Head Island, SC (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/852,371

(22) Filed: May 24, 2004

(51) Int. Cl. G01G 1/38; G01G 7/00

(52) U.S. Cl. 73/760

(57) ABSTRACT

A load-sensing device having a rectangular or round tubular housing with a torque arm member mounted pivotally therein; a camming member mounted coaxially within the housing; a trip member interposed between the load bearing member and the camming member; rolling members interposed between the housing and the camming member such members being able to roll back and forth during the release and re-engagement of the camming mechanism; means to control the position and the amount of travel of the rolling members; means to urge the rolling members into position from which rolling action can occur during actuation; a spring member bearing against the camming member; a spring adjusting means to vary the compression and, thus, the loading force of the spring; and a proportional display means calibrated and labeled with means for indicating the corresponding load.

### TECHNICAL FIELD

The present invention relates generally to load-sensing mechanisms within force-applying tools, and more specifically to an apparatus for signaling an overload condition or signaling when a predetermined load has been reached, including during application of rotational force to a fastening device. The present invention is particularly advantageous in use and application due to an ability to permit highly precise and accurate activation of a sensing mechanism to indicate the achievement of the required load, or, alternatively, to provide visual, tactile or audible indication of a predetermined load having been reached during the application of tortional or linear force.

### BACKGROUND OF THE INVENTION

It is often desirable to apply a load to a load-bearing element without overloading the load-bearing element, and thus, while applying the load it is useful to have a sensing/signaling device to warn of a load level being reached or an overload condition. Load-sensing mechanisms are well known in the art. They are often incorporated as part of a force transmitting device, in order to determine when a limiting force has been applied.

One such force application is the transmission, via a tool, of a limited amount of torque to tighten a fastener without undesired distortion of the fastener itself or the pieces fastened thereby. Mechanically, one often wishes to tighten the fastener to some predetermined force level, usually less than the fastener component's yield strength, which is effective to achieve and maintain a clamping force even in high pressure flexure, or vibration susceptible, environments.

In order to accurately sense a load or torque being applied, it is necessary to signal when the load applied, turning force or torque exceeds a specific level or limit. It is, thus, necessary to have an apparatus which can be incorporated into a force-transmitting device and sense the applied load, turning force or torque, and at the same time accurately signal when the pre-established load or torque limit has been reached.

Various devices exist to measure the attainment of a specific load limit applied to a load-bearing element, or torque limit being applied to a fastener or other article being rotated. Some such devices comprise an indicating mechanism, but lack the ability to set a load limit. The device of Walsh (U.S. Pat. No. 4,029,185) utilizes an indicator arm that provides registration relative to a set of fixed indicia. However, Walsh '185 lacks the ability to set a predetermined limit. The device of Austin (U.S. patent application No. 2002/0023504) utilizes a Belville washer that is compressed, and includes an indicating means to show the level of torque reached. Devices such as Walsh '185 and Austin '504 lack the ability to set a predetermined limit of torque to be applied.

When a predetermined limit is capable of being set, it is desirable to signal the attainment of such a limit in order that application of force or torque can cease or some other corrective action can be undertaken. This is often achieved by a mechanism that provides an audible and/or tactile feedback upon reaching the set limit level of torque. Most typical among the devices providing audible and/or tactile feedback are those of Kemp et al. (U.S. patent application No. 2002/0040628), Grabovac et al. (U.S. Pat. No. 4,732,062), Kaplan (U.S. Pat. No. 5,152,200) and Grabovac (U.S. Pat. No. 5,662,012).

Such cam-type devices as Grabovac '012, Grabovac et al. '062 and Kemp et al. '628 operate by a lever action against a trip block, wherein the trip block is retained within recesses of components in contact with opposite faces of the trip block. One component that holds the trip block is the sliding camming mechanism. The other component is the load-applying member. Force against the camming point of the trip block, applied by the load-applying member against one edge of the trip block, causes the trip block to rotate around the diagonally-opposing edge, since the diagonally-opposing edge is restrained within the sliding camming mechanism at the contact area.

A similar action is seen in Kaplan '200; however, the tripping member is a ball bearing instead of a trip block. As with the devices utilizing a trip block, Kaplan '200 lacks sufficient accuracy and precision for many applications due to the positioning of the ball bearing relative to the sliding camming mechanism.

All the above devices operate by means of a camming action utilizing a tripping member that tilts or rotates upon reaching the preset torque limit; however, due to the positioning of the tripping member relative to the sliding camming mechanism, and friction effects on the sliding camming mechanism, such devices lack high precision and accuracy. Kemp et al. '628 have attempted to improve the accuracy and precision of their device by incorporating ball bearings to reduce friction of the sliding camming member with which the tripping member is in contact. However, because the camming point of the trip member of Kemp et al. '628, at the sliding camming member interface, can move radially, it lacks sufficient ly adequate precision and accuracy for many applications.

When the accuracy of such cam-type devices and their associated sensing mechanisms does not need to be great, and/or when the size and/or the cost of such cam-type devices is of no concern, and/or the release that signals attainment of a predetermined load or overload is unidirectional, devices such as those described above can be utilized.

Low cost, small size, and high-precision, bi-directional cam-type devices including setting, sensing and signaling mechanisms, however, are not available today. Particular design considerations to be addressed in improving the accuracy of cam-type devices are the amount and the variability of friction amongst the various components from which the device is constructed. In a typical low-cost mechanism that activates via tripping of a block, such as those of Grabovac '012 and Grabovac et al. '062, friction may affect the release force value by several percent. To reduce friction and at the same time provide kinematic load-bearing points for the sliding camming mechanism, those of ordinary skill in the art would utilize a combination of highly polished surfaces, low-friction coatings, rotary ball bearings, and/or re-circulating linear ball bearings. These solutions lack selective positioning of the load-bearing points with respect to the camming point as described below, and tend to be either ineffective, only partially effective, costly, and/or relatively large in size.

The relative position of the camming point and the camming mechanism-to-housing load-bearing points is a critical design consideration. In a device of small size, the camming point is usually positioned between the load-applying member itself and the load-bearing points closest to the load-applying member. The farther away the camming point is from the load-bearing points, the greater is the load due to the lever principal. Again, if compact design is not a factor, the camming point can be so positioned as to make the force at the load-bearing points equal to the force required to cause rotation of the trip block (the trip point); otherwise, if the camming point is located away from the load-bearing points, the lever principal causes the load-bearing force to exceed the trip force, thereby leading to undesirable deformation of the contact area and an increase in the amount and variability of friction that can occur.

Another design consideration to be addressed in improving the accuracy of cam-type devices is the manner and implementation of setting the desired load level. Accordingly, in addition to sensing when a load level has been reached, it is first necessary to be able set the load level desired. Typical adjustable-load setting mechanisms such as those of Grabovac '012, Grabovac et al. '062, Kaplan '200 and Kemp et al. 628, utilize a helical spring in contact with the sliding camming mechanism, wherein the spring is compressed a predetermined amount to achieve the desired trip point, and wherein the trip point is a limit setting that equates to the force applied that causes rotation of the trip block.

The spring end is typically ground in order to best form a load-bearing face perpendicular to the spring axis, wherein the spring end contacts the sliding camming member. The spring end typically mates with a flat surface of the sliding camming member, such as a platen. However, due to manufacturing tolerances, a typical spring has a load-bearing face that deviates from perpendicular to the spring axis by a few degrees. Furthermore, the spring may rotate by a random amount during the process of compressing the spring, and during the release and re-engagement of the camming mechanism. The spring end usually defines the high point in the load-bearing face of the spring. Depending on the orientation of the spring end to the camming member, the trip point may vary by several percent. Again, with devices requiring only limited accuracy, this will not be of great concern, but where the required accuracy is on the order of two to four percent of the load limit setting or less, such variation is not acceptable. Accordingly, where precision and accuracy are needed, it is necessary to reduce and/or eliminate rotation of the spring relative to the camming member.

While each the above devices and methods for indication of load or torque may be suitable for some applications, the accuracy and precision of each such device is dependent upon the tripping member and sliding camming mechanism utilized, the design of the interface between the tripping member and the sliding camming mechanism, and the load/force setting mechanism.

Therefore, it is readily apparent that there is a need for a load-sensing mechanism that provides reproducible, accurate results with high precision by improving the sliding camming mechanism and its interface with the tripping member, to overcome the disadvantages of exiting devices. For instance, for a device that utilizes a pivoting trip block, a stable platform that restrains the edges of the trip block is necessary. The stable platform permits repeatable, accurate and precise pivoting of the block when the force applied by the load-applying member reaches the pre-selected limit level, thereby providing similarly accurate and reproducible measurements. For instance, if the pivoting block is permitted to move randomly laterally, then the pivoting action will not take place reproducibly.

There is a further need for such an apparatus that prevent rotation of the load-setting spring in order to improve accuracy.

There is still a further need for such an apparatus that can readily be incorporated into existing load or torque sensing apparatuses with minimal design impact.

As will be more fully detailed hereinbelow, it is to the provision of such an apparatus that the present invention is directed.

### BRIEF SUMMARY OF THE INVENTION

Briefly described, in a preferred embodiment, the present invention overcomes the above-mentioned disadvantages and meets the recognized need for such a device by providing embodiments directed to a load-sensing mechanism of high precision and accuracy, wherein the load-sensing mechanism is located within a rectangular or cylindrical body, such as, for exemplary purposes only, the body of a linear load-limiting apparatus or a torque wrench. The load-sensing mechanism communicates with a compressive spring member, wherein the spring force is set by a compression adjustment mechanism. The load-sensing mechanism has therein a trip member that pivots when a predefined load or torque limit is reached, thereby contacting a sensor to provide an electronic signal that the preset limit of load or torque has been reached. Alternately, the sensor may be a direct mechanical one, indicating the load limit visually or via sound, visible or audible means.

More specifically, the present invention comprises an activation mechanism providing indication of attainment of a pre-established limit of load or torque, wherein the activation mechanism is contained within a rectangular or round tubular housing. A torque arm member is mounted pivotally within the housing, the torque arm member having a generally rectangular depression, wherein the generally rectangular depression has angled sides. A camming member enclosed in a cage is mounted coaxially within the housing, the camming member having a generally rectangular depression therein. A trip member, for exemplary purposes only, generally a rectangular prism, is interposed between the load bearing member and the camming member, and the trip member is seated in the rectangular depressions of both load bearing and camming members. The trip member has two edges perpendicular to the motion of the torque arm member, wherein the edges define the camming edges referenced hereinbelow. Rolling members are interposed between the housing and the camming member, wherein the rolling members roll back and forth during the release and re-engagement of the camming mechanism. The present invention further includes a means to control the position and the amount of travel of the rolling members and a means to urge the rolling members into position from which rolling action can occur during actuation. A spring member bears against the camming member and a spring adjusting means varies the compression and thus, the loading force of the spring. Finally, a display means proportionally reflects the amount of compression of the spring, wherein the display means is calibrated and labeled with the corresponding load limit selected by the user.

Preferably, rolling members are carried by the cage and camming member, wherein the rolling members contact the inside of the housing that comprises the body of a torque wrench or a linear load sensor. The rolling members are carried sufficiently close to the ends of the cylindrical barrel of the camming member to provide support for the cylinder within the housing to constrain lateral deflection of the camming member under load.

The rolling members, in adequate number to provide at least kinematic support of the camming member within the cage, thereby also at least kinematically support the activation mechanism within the housing. A trip member resides in a recess at one end of the camming member, such that prior to the camming action, the base of the recess against which the trip member rests is located directly between two or more rolling members held radially by the cage at one end of the activation mechanism. In this fashion, the camming edge of the trip member also lies directly between two or more of the rolling members located radially around one end of the camming member. A load-applying member exerts force on the trip member and, as force is applied and the trip member begins to pivot, the camming member moves away from the load-applying member allowing further pivoting of the trip member. In so moving, the camming member is retained radially by the rolling members, which also serve to facilitate smooth motion of the camming member. In an alternate embodiment, the camming edge of the trip member can lie away from the line of application of load or torque on the other side of the line between rolling members at one end of the cage of the camming member. An elastic means urges the rolling members and cage away from the camming member to assure that the rolling members will be in position to roll instead of slide, thereby reducing friction and improving accuracy.

A load-transmitting washer is interposed between a spring member and the camming member. The washer has a central truncated spherical projection that contacts a corresponding, but shallower, truncated spherical indentation in the camming member, thereby allowing the washer to tilt to compensate for non-squareness of the end of the spring member. The truncated cone-within-truncated cone relationship preferably prevents the washer from tilting in relation to the camming member by more than approximately ten degrees and prevents rotation of the washer by more than approximately fifteen degrees. The washer has a projection on the spring-facing surface thereof that engages a gap in the closed end of the spring coil, thereby preventing the spring member from rotating in relation to the washer.

Accordingly, a feature and advantage of the present invention is its ability to be utilized to provide a mechanism to sense linear loads that can be incorporated into a load-measuring device.

Another feature and advantage of the present invention is its ability to be utilized to sense rotational force or torque, and further to be incorporated within a force-transmitting device to signal limits of force reached.

Still another feature and advantage of the present invention is its high degree of accuracy.

Yet another feature and advantage of the present invention is high precision of repeatability of sensing force application at a desired limit.

Yet still another feature and advantage of the present invention is its ability to be readily designed into standard load-sensing and/or torque-applying tools.

A further feature and advantage of the present invention is its ease of manufacture.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a cross-sectional view of a torque-sensing apparatus according to a preferred embodiment of the present invention before activation;

FIG. 1B is a partial cross-sectional view of a torque-sensing apparatus according to a preferred embodiment of the present invention after activation;

FIG. 1C is a cross-sectional view of a load-sensing apparatus according to a preferred embodiment of the present invention before activation;

FIG. 2A is a front view of the first end of an activation mechanism according to a preferred embodiment of the present invention;

FIG. 2B is a top view of an activation mechanism according to a preferred embodiment of the present invention;

FIG. 2C is a side view of an activation mechanism according to a preferred embodiment of the present invention;

FIG. 3 is a rear view of an activation mechanism according to a preferred embodiment of the present invention;

FIG. 4A is a top view of a load-transmitting washer according to a preferred embodiment of the present invention;

FIG. 4B is a side view of a load-transmitting washer according to a preferred embodiment of the present invention;

FIG. 5A is a side detail view of an activation mechanism and an untilted load-transmitting washer according to a preferred embodiment of the present invention; and

FIG. 5B is a side detail view of an activation mechanism and a tilted load-transmitting washer according to a preferred embodiment of the present invention.

### DETAILED DESCRIPTION OF THE PREFERRED AND ALTERNATIVE EMBODIMENTS

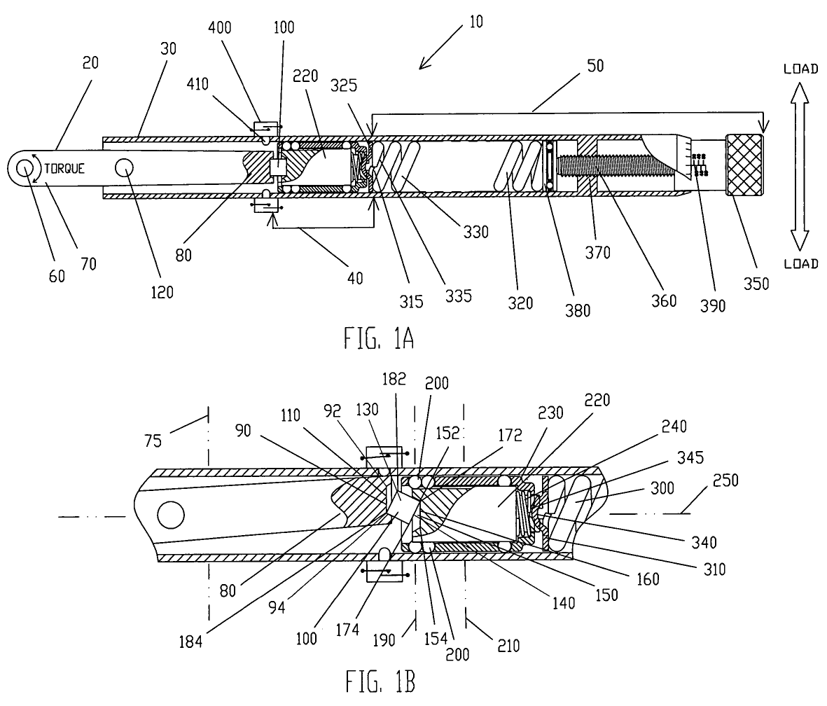

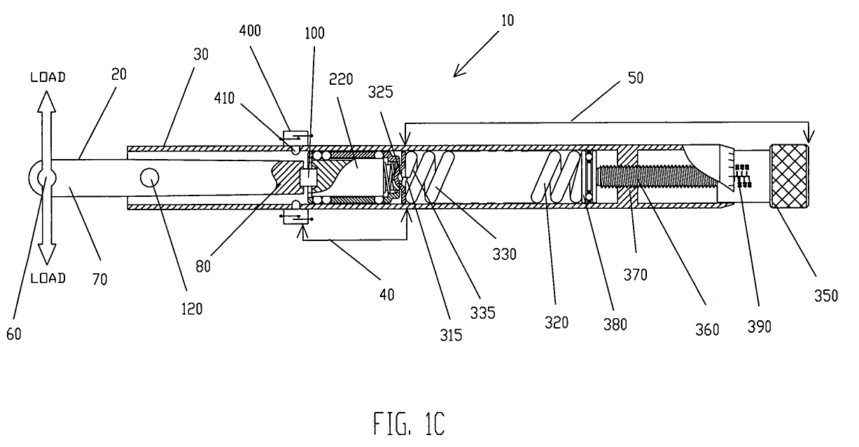

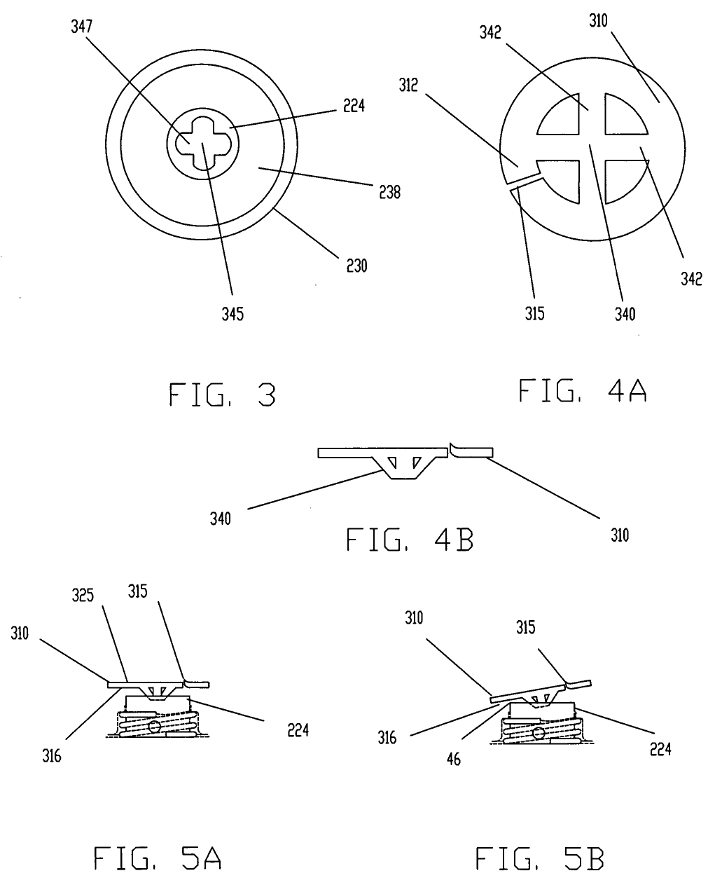

In describing the preferred and selected alternate embodiments of the present invention, as illustrated in FIGS. 1A-5B, specific terminology is employed for the sake of clarity. The invention, however, is not intended to be limited to the specific terminology so selected, and it is to be understood that each specific element includes all technical equivalents that operate in a similar manner to accomplish similar functions.

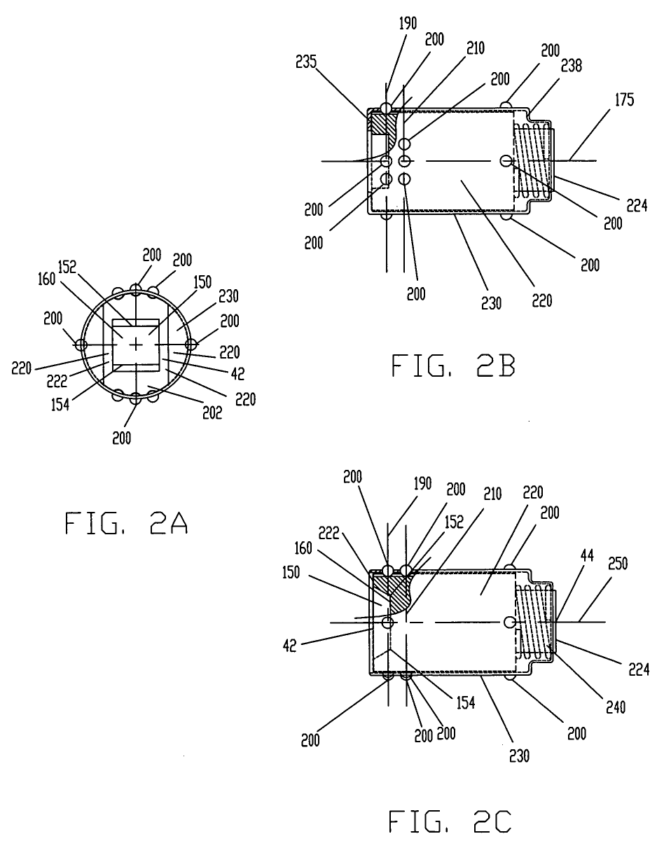

Referring now to FIGS. 1A-5B, the present invention in a preferred embodiment of apparatus 10 comprises rectangular or round tubular housing 30 having torque arm member 20 pivotally mounted therein, generally cubic-shaped trip member 100, activation mechanism 40 (best shown in FIG. 2) slidably mounted within housing 30, and load-setting mechanism 50. Trip member 100 communicates between torque arm member 20 and activation mechanism 40, wherein activation mechanism 40 is acted upon by torque arm member 20 and trip member 100 is released to tilt by activation mechanism 40, as is more fully described below.

In operation, apparatus 10 is utilized to sense a linear load or to apply a torque to a fastener or similar device up to a pre-selected limit value, and upon reaching such value to provide a signal that the limit has been reached. Upon selection of apparatus 10 for a torque-applying task, a limiting value is set via torque-setting mechanism 50. Torque arm member 20 is then connected to the fastener, or like, via means for connecting 60. Means for connecting 60 is preferably any suitable engagement device to operate on a work-piece as is known in the art, such as, for exemplary purposes only a square socket mounting portion suitable for engagement with a hexagonal socket. Alternately, such other means for connecting 60 could include a hexagonal drive, open wrench jaws, a box wrench head, or the like. As torque is applied to the work-piece by apparatus 10, eventually the pre-selected limiting torque value is reached and torque arm member 20 rotates about its pivot point causing activation mechanism 40 to allow deflection of trip member 100. As trip member 100 is moved from its resting position as shown in FIG. 1A to its tilted position shown in FIG. 1B, it permits torque arm member 20 to activate signaling mechanism 400.

Further describing the specific construction and operation of torque-setting mechanism 50, rotation of knurled knob 350 turns load screw 360, wherein load screw 360 is retained in threaded throughhole 370. Rotation of knurled knob 350 varies the position of thrust washer 380 and thus the compressive load of coil spring 300. Increasing compressive force translates to increasing force applied by torque arm member 20 to trip member 100, thus requiring increased load force to be applied to cause trip member 100 to pivot. Correspondingly, less force applied via coil spring 300 and washer 310 translates to pivoting of trip member 100 with less force applied by torque arm member 20. The level of force applied via coil spring 300 is proportionally shown on displaying means 390, such as, for exemplary purposes only, a vernier scale.

Torque-setting mechanism 50 preferably comprises coil spring 300, wherein coil spring 300 provides a compressive force against washer 310. Load-transmitting washer 310 lies between coil spring 300 and cage 230 of camming member 220. Washer 310 has central truncated spherical projection 340 contacting a corresponding, but shallower truncated spherical indentation 345 in second end 224 of camming member 220. Spherical projection 340 and spherical indentation 345 allows washer 310 to tilt to compensate for non-squareness of coil spring 300, but contact of washer bottom 316 with edge 46 of second end 224 of camming member 220 constrains washer 310 from tilting in relation to camming member 220 by more than approximately ten degrees, as best shown in FIGS. 5A and 5B. Washer 310 further comprises cross legs 342, wherein cross legs 342 interlock with cross indent 347 in spherical indentation 345, thereby constraining washer 310 from rotating in relation to camming member 220 by more than approximately fifteen degrees. First end 330 of coil spring 300 is seated on the flat portion of face 325 of washer 310. Washer 310 has projection 315 formed by separation of projection 315 from, and bending away from, washer ring 312, wherein projection 315 is located on spring-facing face 325 of washer 310. Projection 315 engages gap 335 in first end 330 of coil spring 300; thereby, constraining coil spring 300 from rotating in relation to washer 310. Central truncated spherical projection 340, in combination with force exerted by coil spring 300, constrains rotation of coil spring 300. Spring force maintains trip member 100 in a normal, un-pivoted, position until a limit or overload condition is reached as defined by a load or force that overcomes the compressive force of coil spring 300.

Further describing the specific construction and operation of torque arm member 20, torque arm member 20 has first end 70, and means for connecting 60, such as, for exemplary purposes only for torque applications, a socket drive as is known in the art. Torque arm member 20 has second end 80, wherein second end 80 comprises recess 90 in communication with trip member 100, wherein recess 90 is a generally rectangular depression and comprises corner edges 92, 94 and surface 110. Means for connecting 60 is located proximate first end 70, wherein means for connecting 60 facilitates communication with a work piece for the purpose of applying load or torque thereto.

Activation mechanism 40 (best shown in FIG. 2) is mounted coaxially within housing 30, wherein activation mechanism 40 communicates with trip member 100, and comprises camming member 220, cage 230, biasing spring 240 and rolling members 200. Depending upon the shape of housing 30, rolling members 200 can be either cylindrical or spherical in shape. Activation mechanism 40 comprises first end 42, second end 44 and camming member 220, wherein camming member 220 comprises first end 222 and second end 224. First end 222 of camming member 220 has generally rectangular depression 150 therein, wherein generally rectangular depression 150 comprises corner edges 152, 154 and surface 160.

Returning to FIGS. 1A and 1B, trip member 100, for exemplary purposes only, generally comprises a rectangular prism, and is interposed between torque arm member 20 and camming member 220. Trip member 100 is seated in recess 90 of torque arm member 20, wherein recess 90 is dimensioned to receive first face 130 of trip member 100. First face 130 lies proximate to surface 110 of recess 90 prior to activation. Second face 140 lies proximate to surface 160 of depression 150 prior to activation.

First face 130 of trip member 100 has camming edges 182 and 184. Camming edges 182 and 184 are carried perpendicular to motion axis 75 of torque arm member 20. Second face 140 of trip member 100 has camming edges 172 and 174 thereon, wherein camming edges 172 and 174 are carried perpendicular to motion axis 250 of camming member 220.

Second face 140 of trip member 100 is received by depression 150 in camming member 220 (best shown in FIG. 2), whereby second face 140 lies proximate surface 160 of camming member 220 prior to activation. Surface 160 has corner edges 152 and 154. Second face 140 of trip member 100 has camming edges 172 and 174. Camming edge 172 lies proximate corner edge 152 and camming edge 174 lies proximate corner edge 154 prior to activation.

Rolling members 200 are interposed between housing 30 and activation mechanism 40, and are carried by cage 230, wherein rolling members 200 roll back and forth during release and re-engagement of camming member 220. Rolling members 200 complement the shape of housing 30, wherein rolling members 200 are cylindrical for a rectangular embodiment of housing 30 or spherical for a round embodiment of tubular housing 30. Position and travel of rolling members 200 is controlled via longitudinal races 202, cage 230 and biasing spring 240. Biasing spring 240 urges rolling members 200 into position, whereby rolling action occurs during activation of camming member 220.

Rolling members 200 support camming member 220 coincident within cage 230, wherein rolling members 200 facilitate motion of camming member 220 along motion axis 250. As is more fully described below, location of rolling members 200 near extremes of cage 230 serves to keep camming member 220 and cage 230 aligned within housing 30, thereby contributing to the accuracy and precision of the torque to be applied via, or measurement of load applied to, apparatus 10. Camming member 220 is further restrained from excessive movement relative to cage 230 by lips 235 and cage end 238 of cage 230, thereby securing camming member 220 within cage 230, while second end 224 of camming member 220 slidably passes through cage end 238.

When camming member is at its rest position, corner edges 152 and 154 lie coincident with centerline 190 through rolling members 200 and/or between centerline 190 through rolling members 200 and centerline 210 through rolling members 200. Camming edges 172 and 174 of trip member 100 lie within centerline 190 through rolling members 200 and centerline 210 through rolling members 200. Rolling members 200 support camming member 220 without radial deflection from forces applied to corner edges 152 and 154, thereby reducing the load on rolling members 200 and contributing to the accuracy and precision of torque to be applied, limited or measured.

In operation, a desired torque is selected and set on displaying means 390 via knurled knob 350. Means 60 is connected to a work-piece and force is applied to apparatus 10, generating torque at means for connecting 60. The load is applied to load-sensing device 10. Torque arm member 20 is rotationally-attached to pivot pin 120. Upon the application of torque to a fastener or the like, wherein the torque force exceeds a user's specifically-preset limit, torque arm member 20 pivots about pivot pin 120. Second end 80 moves laterally as torque arm member 20 pivots about pivot pin 120, thereby causing recess 90 to move and apply force to camming edge 184 of trip member 100. As force is applied to camming edge 184, camming edge 184 of trip member 100 moves away from the application of force. Trip member 100 pivots or tilts about camming edge 172 (as best shown in FIG. 1B), and activation mechanism 40 moves axially to permit such tilting by trip member 100, as is more fully described below.

Upon reaching the selected load, torque arm member 20 deflects rotationally about pivot pin 120. As force of coil spring 300 is overcome, camming member 220 retreats from torque arm member 20; thereby, causing surface 160 to migrate from proximate centerline 190 in the direction away from torque arm member 20. Rolling members 200 thus support camming member 220 and surface 160 preventing lateral movement of camming member 220.

As camming member 220 migrates from torque arm member 20, trip member 100 deflects and rotates about corner edge 152 and camming edge 184, or about camming corner edge 154 and camming edge 182, depending on the direction of deflection of torque arm member 20. As trip member 100 deflects, second end 80 of torque arm member 20 contacts slidable protuberance 410, thereby activating signaling mechanism 400. Signaling mechanism 400 is any device or means that can send an audible, tactile or electronic signal, such as is known by those with ordinary skill in the art, whereby a user can determine when a preset limit has been reached. As force or load is applied and camming member 220 migrates, biasing spring 240 urges rolling members away from torque arm member 20, facilitating a rolling movement of rolling members 200 and, thereby, preventing undesirable sliding of rolling members 200.

Upon relaxation of load or torque, biasing spring 240 causes camming member 220 to return to its original position (best shown in FIG. 1A) within activation mechanism 40, thereby permitting face 140 of trip member 100 to return proximate surface 160. As force or load is released and camming member 220 migrates back to its resting position, biasing spring 240 urges rolling members away from torque arm member 20, facilitating a rolling movement of rolling members 200 and thereby preventing sliding of rolling members 200.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. A load-sensing device comprising:
a trip member comprising a camming edge;
a camming member comprising a motion axis;
a plurality of rolling members carried by said camming member;
wherein said camming member comprises a first end, a center and a second end, at least two of said plurality of rolling members located proximate said first end, wherein said first end lies proximate said trip member, and wherein said first end comprises a generally rectangular depression therein, said camming edge lying between said center of said camming member and a centerline through said at least two of said plurality of rolling members located at said first end of said camming member.

2. The load-sensing device of claim 1, further comprising:
a torque arm member, said torque arm member comprising a generally rectangular depression therein, and wherein said torque arm member comprises a motion axis, wherein said trip member is interposed between said torque arm member and said camming member, and wherein said trip member is seated in said generally rectangular depressions in said torque arm member and said camming member.

3. The load-sensing device of claim 2, further comprising:
a tubular housing, wherein said camming member is mounted coaxially within said housing, and wherein said torque arm is mounted within said housing;
a spring member bearing against said camming member; and
spring adjusting means for varying compression of said spring member.

4. The load-sensing device of claim 3, wherein said trip member comprises a first face and first parallel edges, wherein said first parallel edges define limits of said first face, wherein said first face is carried proximate said generally rectangular depression in said torque arm, and wherein said first edges of said trip member lie perpendicular to said motion axis of said torque arm member.

5. The load-sensing device of claim 4, wherein said generally rectangular depression in said torque arm comprises angled sides.

6. The load-sensing device of claim 4, wherein said trip member comprises second face and second parallel edges defining limits of said second face, wherein said second face is carried proximate said generally rectangular depression in said camming member, and wherein said second parallel edges of said trip member are perpendicular to said motion axis of said camming member.

7. The load-sensing device of claim 1, wherein said rolling members are selected from the group consisting of cylindrical rolling members and spherical rolling members.

8. The load-sensing device of claim 3, wherein said plurality of rolling members are interposed between said housing and said camming member, said plurality of rolling members travelling back and forth during release and re-engagement of said camming mechanism.

9. The load-sensing device of claim 8, further comprising means to control position and amount of travel of said plurality of rolling members.

10. The load-sensing device of claim 9, further comprising means to urge said plurality of rolling members into position from which rolling action can occur during actuation.

11. The load-sensing device of claim 3, further comprising display means proportional to an amount of compression of said spring member, wherein said display means further comprises calibrated and labeled indicia.

12. The load-sensing device of claim 2, wherein said motion axis of said torque arm member is perpendicular to said motion axis of said camming member.

13. The load-sensing device of claim 3, further comprising a washer interposed between said spring member and said camming member.

14. The load-sensing device of claim 13, wherein said washer comprises an indentation therein and wherein said indentation lies proximate said camming member.

15. The load-sensing device of claim 14, wherein said spring comprises a first end, and wherein said first end lies proximate said indentation in said washer.

16. A method of signaling when a limit of load has been achieved, said method comprising the steps of:
a. obtaining a load sensing device comprising a signaling appliance therein, said signaling appliance comprising;
a cylinder comprising a surface and two ends, and at least two bearings carried by said cylinder, wherein said at least two bearings comprise bearings located proximate said ends of said cylinder,
a torque arm member, and
a trip member, wherein said signaling appliance is activated by said torque arm member;
b. connecting said load-sensing device to a load;
c. applying the load to said load-sensing device; and
d. obtaining a signal from said signaling appliance.

17. The method of claim 16, further comprising the step of:
a′. setting a specific load level on said load-sensing device.

18. A load-sensing mechanism comprising:
a torque arm member;
a camming member enclosed in a housing with at least two rolling members interposed between said camming member and said housing; and
a trip member comprising at least one cramming edge, wherein said camming edge is carried between said at least two rolling members, wherein said camming member performs a camming action upon application of a load to said torque arm member.

19. The load-sensing mechanism of claim 18, said camming member further comprising a recess, wherein said at least two rolling members comprise at least one bearing located proximate said recess when said camming member is in its resting position.

20. The load-sensing mechanism of claim 19, further comprising a camming spring, wherein said at least two rolling members comprise at least one bearing located proximal to said camming spring.

21. The load-sensing mechanism of claim 20, said camming member further comprising at least one bearing lying proximal to said at least one bearing located proximate said recess, and wherein said camming edge lies between a centerline through said at least one bearing located proximate said recess and a centerline through said at least one bearing lying proximal to said at least one bearing located proximate said recess.

22. The load-sensing mechanism of claim 18, wherein said camming member moves away from said torque arm member during said camming action.

23. A load-sensing mechanism comprising:
a camming member having a plurality of rolling members; and
an elastic means, wherein said elastic means is adapted to urge said plurality of rolling members away from a load bearing member.

24. A load-sensing mechanism comprising:
a spring member;
a camming member; and
a load-transmitting washer between said spring member and said camming member, wherein said load-transmitting washer comprises a central truncated spherical projection therein, and wherein said central truncated spherical projection contacts a corresponding, but shallower truncated spherical indentation in said camming member, and wherein said washer tilts to compensate for non-squareness of said spring member, and wherein said washer tilts in relation to said camming member by approximately ten degrees or less, and wherein said washer rotates in relation to said camming member by approximately fifteen degrees or less.

25. The load-sensing device of claim 1, further comprising a spring member and a load-transmitting washer between said spring member and said camming member, wherein said load-transmitting washer comprises a central truncated spherical projection therein, and wherein said central truncated spherical projection contacts a corresponding, but shallower truncated spherical indentation in said camming member, and wherein said washer tilts to compensate for non-squareness of said spring member, and wherein said washer tilts in relation to said camming member by approximately ten degrees or less, and wherein said washer rotates in relation to said camming member by approximately fifteen degrees or less, and wherein said washer further comprises a tab projection.

26. The load-sensing device of claim 25, further comprising a force-applying spring, wherein said force-applying spring lies proximate said tab projection.

27. The load-sensing device of claim 26, wherein said tab projection is disposed to engage an end of said force-applying spring and wherein said spring member is constrained from rotation by said tab projection.
